(19) United States
(12) Patent Application Publication
(10) Pub. No.: US 2005/0031405 A1
(43) Pub. Date: Feb. 10, 2005

(54) Constructive arrangement applied to a nail-polish pen

(76) Inventors: Raquel Heneghini Carneiro, Porto Alegre (BR); Admar Josoe de Menezes, Porto Alegre (BR)

Correspondence Address: Welsh & Katz, Ltd.;Jon P. Christensen, 22nd Floor, 120 South Riverside Plaza, Chicago, IL, 60606, US

(21) Appl. No.: 10/854,955

(22) Filed: May 27, 2004

(30) Foreign Application Priority Data
Jul. 31, 2003 (BR) 03043355

(51) Int. Cl. B43K 5/18; A47L 13/30

(52) U.S. Cl. 401/264; 401/263

(57) ABSTRACT

Constructive arrangement applied to a nail-polish pen, designed like a small pen, easy to carry so as to be readily available for immediate use, with a fine applicator; which enables to draw details; and do finishing touches simply and efficiently.

### INTRODUCTION

The following invention report describes the constructive arrangement applied to a nail-polish pen, designed like a small pen, easy to carry so as to be readily available for immediate use, with a fine applicator which enables to draw details, and do finishing touches simply and efficiently.

### STATE OF THE TECHNIQUE

It is a well-known fact that nail polish is a cosmetic to give nails their smooth, polished look, and chosen color, while protecting them against breakage. Nail polish is traditionally marketed in small glass pots whose lid has a brush that is used to paint the nails.

The following papers were selected from the surveys conducted in the state of the technique:

-PI 9.501.545, filed on Apr. 12, 1995, under the title CONTAINER PLACED BETWEEN FINGERS WITH NAIL-POLISH APPLICATOR, of the type that includes a reservoir (1) equipped with a lid (2) with an axial brush (3) to draw the nail polish out of the reservoir and apply it to the nails. The reservoir (1) has a pair of opposed curved nooks/dents (4) of a specific dimension so as to fit the user's finger and maintain both fingers apart from one another while the nail polish is applied.

-PI 9.802.152, filed on Jun. 3, 1998, under the title NAIL POLISH PACKAGING IN THE FORMAT OF A BRUSH, made up of a sealing cap 1, the main body having ‘brush’ like bristles 2 set on the measuring-spout 3 which receives the nail polish from the storage body 4 placed in the internal compartment 5, whereby the entire set applies the nail polish directly onto the nails.

-PI 9.601.790, file on Jun. 4, 1996, under the title LIQUID OR VISCOUS PRODUCT APPLYING SET AND NAIL-POLSIH APPLYING SET, referring to a set used to apply liquid or viscous products, which is made up of a bottle-necked (8) container (4) with a cap (6) and an submerged applying device (20) placed so as to fill up with the product contained in the said container, whereby the above-mentioned bottle-neck has a base (10) and an upper end (13), and a bottle-neck base is shaped in such a way that whenever the applying device is pressed on its end, the product trickles mainly down the internal wall (21) of the container. The invention also refers to a applying set for liquid or viscous products, made up of a bottle-necked (8) container and a cap (6) with a submersed applying device (20) which fills up with the product contained in the said container, whereby the said bottle neck has a base (10) and a support-free end (13).

### SUMMARY OF THE INVENTION

The above state of the technique reveals the concern in presenting a different nail polish applying device from the conventional cap-brush. Moreover, despite the known diversity of devices available, no pen-like nail polish applicator is available as yet.

Therefore, given the previous observations, this invention report aims at designing a nail-polish pen with the following features:
It is an nail polish applying device, built so as to have the format of a cylinder and equipped with a penpoint-type tip;
It has a reservoir to hold the nail polish that is driven out by gravity;
It has an internal spring that moves a retracting/forward driving device that commands the nail polish discharge whenever the tip is pressed onto the nail;

It has a protecting cap for the tip to avoid damage and stop the nail polish from drying in the pen.

### DESCRIPTION OF THE ILLUSTRATION

The invention-filing request proposed herein is supplied with a drawing representing the constructive arrangement when applied to a nail-polish pen so that the device is entirely reproduced, using the proper technique, thereby enabling the object in focus herein to be fully specified.

The descriptive report is based on the FIGURE devised which expresses the best, or preferred way of designing the product contemplated through a detailed and consecutive enumeration, explaining the aspects likely to be implied by the representation adopted in order to clearly determine the protection of the interest herein.

This FIGURE is but a mere illustration and may be changed, as long as the variations do not stray from the initial purpose in focus herein.

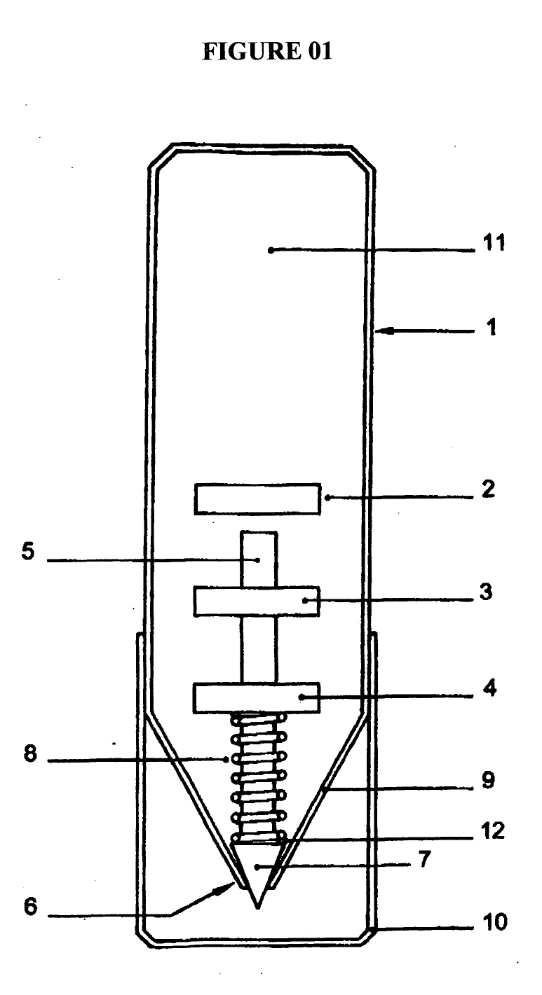

In this case, we have the FIG. 1 which illustrates a schematic view of a partial section of the proposed pen showing the internal mechanism, enabling the product to operating.

### DETAILED DESCRIPTION OF THE INVENTION

The pen proposed has a noticeably cylindrical body 1 whose dimensions make it practical to use, and a lower end that has three levels 2, 3 and 4 which communicate, and enable the appropriate discharge of the volume of nail polish required; the nail polish is appropriately contained inside a reservoir 11, whose upper protection 2 serves as a piston 5 stop that can displace itself freely from the end 6 of the pen 1 to the stop 2, thereby going through levels 3, and 4; the said piston 5 is operated by pressing the tip 7 onto the nail to paint it; it also has a spring 8, which counterbalances the pressure of the tip 7 onto the nail by getting stuck between level 4 and a setoff 12 to be found on the tip 7; for this purpose, the tip 7 has a conical format to settle perfectly on the penpoint 9 and form the seal where the nail polish is driven out, and the air let in; the said pen 1 also has a cap 10 that protects the tip 7 against any damages.

1. Constructive arrangement applied to a nail-polish pen, characterized by the fact that it has a noticeable cylindrical body of dimensions whose dimensions make it practical to use, and a lower end that has three levels 2, 3, and 4 which communicate, and enable the appropriate discharge of the volume of nail polish required;
the nail polish is appropriately contained inside a reservoir 11, whose upper protection 2 serves as a piston 5 stop that can displace itself freely from the end 6 of the pen 1 to the stop 2, thereby going through levels 3, and 4;
the said piston 5 is operated by pressing the tip 7 onto the nail to paint it;
it also has a spring 8, which counterbalances the pressure of the tip 7 onto the nail by getting stuck between level 4 and a setoff 12 to be found on the tip 7;
for this purpose, the tip 7 has a conical format to settle perfectly on the penpoint 9 and form the seal where the nail polish is driven out, and the air let in;
the said pen 1 also has a cap 10 that protects the tip 7 against any damages.
